(19) United States
(12) Patent Application Publication
(10) Pub. No.: US 2013/0166503 A1
(43) Pub. Date: Jun. 27, 2013

(54) FILE CLOUD SERVICE APPARATUS AND METHOD

(71) Applicants: Ki Sook CHUNG, Daejeon (KR); Jong Choul YIM, Daejeon (KR)

(72) Inventors: Ki Sook CHUNG, Daejeon (KR); Jong Choul YIM, Daejeon (KR)

(73) Assignee: Electronics and Telecommunications Research Institute, Daejeon (KR)

(21) Appl. No.: 13/609,856

(22) Filed: Sep. 11, 2012

(30) Foreign Application Priority Data
Dec. 27, 2011 (KR) 10-2011-0143943

(51) Int. Cl. G06F 17/30

(52) U.S. Cl. 707/610; 707/758; 707/748; 707/E17.01

(57) ABSTRACT

Disclosed is a file cloud service apparatus that is not a file cloud system for simply sharing a file between users, but a social file cloud server that enables social information about a file shared within a group to be used by including a comment of a user or scores on a file in file metadata information in group sharing. The file cloud service apparatus may construct a single system together with a file cloud client apparatus by adding social information of the user on the file and thereby may provide an efficient social sharing service. The file cloud service apparatus becomes a base for providing a user-oriented file cloud service.

### CROSS-REFERENCE TO RELATED APPLICATIONS

This application claims priority to and the benefit of Korean Patent Application No. 10-2011-0143943 filed in the Korean Intellectual Property Office on Dec. 27, 2011, the entire contents of which are incorporated herein by reference.

### TECHNICAL FIELD

The present invention relates to a file cloud service apparatus and method, and more particularly, to a file cloud service apparatus and method using metadata.

### BACKGROUND ART

A file cloud service is a service that provides a file repository so that users may access and use a file without restriction on a time and a place, and enables access of various terminals through the Internet. Consequently, a plurality of users having the right with respect to a single file may share the file. Regardless of a location, a single user may read and edit a file at any time using various Internet devices such as a smart phone, a desktop, and the like.

When the above file cloud service is constructed within a company, it is possible to provide an effective base for knowledge sharing and cooperation within the company. The file cloud service provides a method that makes it possible to synchronize and thereby use a predetermined folder or file within a local device of users through a central repository, and enables the users to use a file through a cloud client (desktop and a mobile device) or a web browser that is executed in the local device.

However, the conventional file cloud service is constructed as a file cloud service for simple file sharing between users and has some constraints in providing a user-oriented file cloud service.

### SUMMARY OF THE INVENTION

The present invention has been made in an effort to provide a file cloud service apparatus and method that provides a user-oriented file cloud service by adding social information associated with a plurality of users to metadata and thereby providing comments and preferences of users on a file.

An exemplary embodiment of the present invention provides a file cloud service apparatus, including: a request message analyzer to analyze a request message associated with a file cloud service when the request message is received; a keyword interpreter to interpret a keyword included in the request message when the analysis result is a search; a file extractor to extract, from among pre-stored files, a file that matches a file name when the keyword is the file name; a file feature information extractor to extract file feature information associated with the keyword from among file feature information generated by a user using a file, when the keyword is not the file name; and a response message transmitter to include the extracted file or the extracted file feature information in a response message to the request message and to thereby transmit the response message.

The file feature information extractor may extract, as the file feature information, at least one of a comment of a user on the file, and scores and preference of the user on the file that are included in metadata.

The file cloud service apparatus may further include a synchronizer to perform synchronization with all the terminals that receive a file cloud service for a shared file for updating, when content of the shared file being shared or metadata of the shared file is modified.

The file cloud service apparatus may further include: a terminal authenticator to authenticate a transmission terminal having transmitted the request message when the analysis result is not the search; an extraction target determining unit to determine whether to extract the file with respect to the authenticated transmission terminal, or whether to extract metadata including the file feature information; and a file/metadata processing unit to process the extracted file or metadata based on the determination. The file/metadata processing unit may modify content of metadata associated with a shared file when content of the shared file being shared is modified.

In response to a request of a terminal having received the extracted file feature information, the file extractor may extract a feature information based file, based on the extracted file feature information. The file extractor may extract at least one of a file that includes a comment of a user selected using the feature information based file, a file that includes a word selected by the comment of the user, and a file of which scores or preference is greater than or equal to a reference value.

Another exemplary embodiment of the present invention provides a file cloud service method, including: analyzing a request message associated with a file cloud service when the request message is received; interpreting a keyword included in the request message when the analysis result is a search; extracting, from among pre-stored files, a file that matches a file name when the keyword is the file name; extracting file feature information associated with the keyword from among file feature information generated by a user using a file, when the keyword is not the file name; and including the extracted file or the extracted file feature information in a response message to the request message to thereby transmit the response message.

The extracting of the file feature information may extract, as the file feature information, at least one of a comment of a user on the file, and scores and preference of the user on the file that are included in metadata.

The file cloud service method may further include performing synchronization with all the terminals that receive a file cloud service for a shared file for updating, when content of the shared file being shared or metadata of the shared file is modified.

The file cloud service method may further include: authenticating a transmission terminal having transmitted the request message when the analysis result is not the search; determining whether to extract the file with respect to the authenticated transmission terminal, or whether to extract metadata including the file feature information; and processing the extracted file or metadata based on the determination. The processing of the file or the metadata may modify content of metadata associated with a shared file when content of the shared file being shared is modified.

The extracting of the file may extract a feature information based file based on the extracted file feature information in response to a request of a terminal having received the extracted file feature information, and may extract at least one of a file that includes a comment of a user selected using the feature information based file, a file that includes a word selected by the comment of the user, and a file of which scores or preference is greater than or equal to a reference value.

According to exemplary embodiments of the present invention, provided are a method and apparatus that provide a social file cloud service by including additional information such as a user comment, scores, a tag, and the like in file metadata. When a group is generated within a company or a community, and when a file is shared between groups, not a general file cloud service but a user-oriented social file cloud service is enabled by storing and sharing comments or preferences of other users on a file. If necessary, it is possible to perform various social searches on a file such as a search for a file on which a predetermined user has recorded a comment, a search for a file having a comment that includes a predetermined word, and the like. In particular, the present invention may be effectively employed for knowledge exchange and comment exchange in a company that desires to achieve the cooperation and knowledge sharing effect through a file cloud.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating a file cloud service apparatus according to an exemplary embodiment of the present invention.

FIGS. 2A and 2B are block diagrams schematically illustrating a configuration added to the file cloud service apparatus of FIG. 1.

FIG. 3 is a block diagram illustrating a structure of a social file cloud service providing system using file metadata.

FIG. 4 is a block diagram illustrating a structure of a social file cloud server.

FIGS. 5A and 5B are diagrams illustrating a structure and an attribute of file metadata.

FIG. 6 is a flowchart illustrating a procedure associated with a file read and search in a file cloud service.

FIG. 7 is a flowchart illustrating a file cloud service method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. When assigning reference numerals to constituent elements of each drawing, like reference numerals refer to like elements throughout the specification, even though they are illustrated in different drawings. When it is determined the detailed description related to a related known function or configuration may make the purpose of the present invention unnecessarily ambiguous in describing the present invention, the detailed description will be omitted here. Even though an exemplary embodiment of the present invention will be described, the technical spirit of the present invention is not limited thereto or restricted thereby and may be variously modified and thereby be implemented by those skilled in the art.

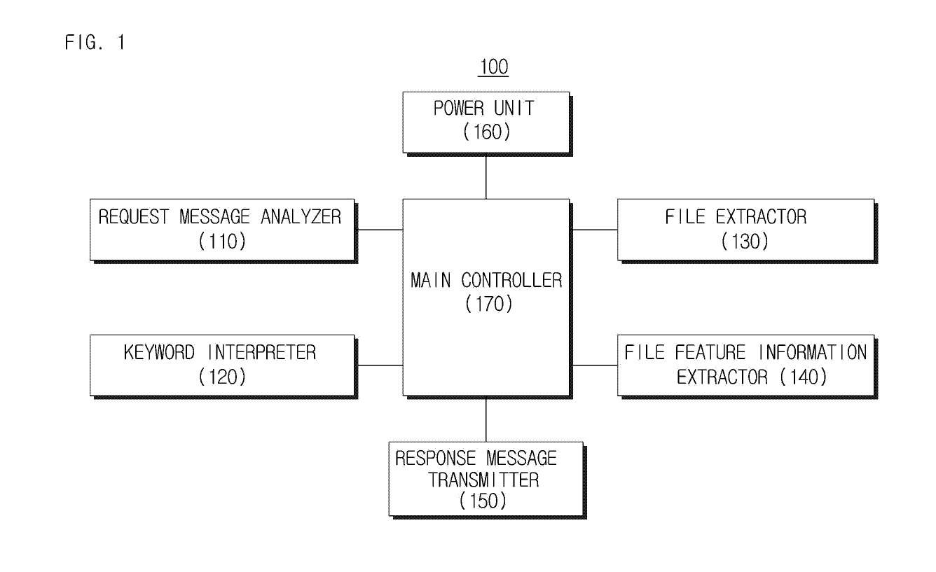

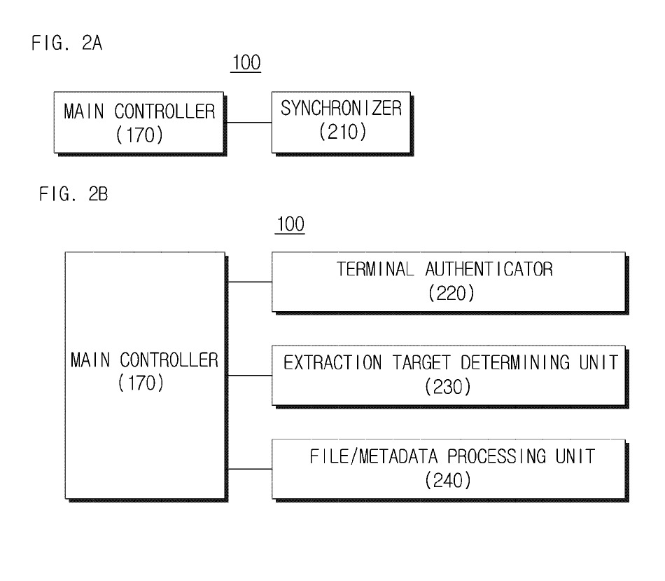

FIG. 1 is a block diagram schematically illustrating a file cloud service apparatus 100 according to an exemplary embodiment of the present invention. FIGS. 2A and 2B are block diagrams schematically illustrating a configuration added to the file cloud service apparatus 100 of FIG. 1. Hereinafter, a description will be made with reference to FIGS. 1 and 2.

Referring to FIG. 1, the file cloud service apparatus 100 includes a request message analyzer 110, a keyword interpreter 120, a file extractor 130, a file feature information extractor 140, a response message transmitter 150, a power unit 160, and a main controller 170. The file cloud service apparatus 100 is configured to perform the same function as a social file cloud server, which will be described later.

The file cloud service apparatus 100 is not a file cloud system for simply sharing a file between users, but a social file cloud server that enables social information about a file shared within a group to be used by including a user comment or scores on a file in file metadata information in group sharing. The file cloud service apparatus 100 may construct a single system together with a file cloud client apparatus by adding social information of the user on the file and thereby may provide an efficient social sharing service. The file cloud service apparatus 100 becomes a base for providing a user-oriented file cloud service.

When a request message associated with a file cloud service is received, the request message analyzer 110 functions to analyze the request message. The request message analyzer 110 is configured to perform the same function as an input/output (I/O) manager, which will be described later.

When an analysis result of the request message is a search, the keyword interpreter 120 functions to interpret a keyword included in the request message. The keyword interpreter 120 is configured to perform the same function as a search engine, which will be described later.

When the keyword is a file name, the file extractor 130 functions to extract, from among pre-stored files, a file that matches the file name. In response to a request of a terminal having received extracted file feature information, the file extractor 130 may extract a feature information based file, based on the extracted file feature information. Here, the file extractor 130 may extract at least one of a file that includes a comment of a user selected using the feature information based file, a file that includes a word selected by the comment of the user, and a file of which scores or preference is greater than or equal to a reference value. The file extractor 130 is configured to perform the same function as a file handler, which will be described later.

When the keyword is not the file name, the file feature information extractor 140 functions to extract file feature information associated with the keyword from among file feature information generated by a user using a file. The file feature information extractor 140 may extract, as the file feature information, at least one of a comment of the user on the file, and scores and preference of the user on the file that are included in metadata. The file feature information extractor 140 is configured to perform the same function as a metadata handler, which will be described later.

The response message transmitter 150 functions to include the extracted file or the extracted file feature information in a response message to the request message and to thereby transmit the response message.

The power unit 160 functions to supply power to each of constituent elements that constitute the file cloud service apparatus 100.

The main controller 170 functions to control the overall operation of each of constituent elements that constitute the file cloud service apparatus 100.

As shown in FIG. 2A, the file cloud service apparatus 100 may further include a synchronizer 210. When content of a shared file being shared or metadata of a shared file is modified, the synchronizer 210 performs synchronization with all the terminals that receive a file cloud service for the shared file for updating.

As shown in FIG. 2B, the file cloud service apparatus 100 may further include at least one of a terminal authenticator 220, an extraction target determining unit 230, and a file/metadata processing unit 240.

When the analysis result of the request message is not the search, the terminal authenticator 220 functions to authenticate a transmission terminal having transmitted the request message.

The extraction target determining unit 230 functions to determine whether to extract the file with respect to the authenticated transmission terminal, or whether to extract metadata including the file feature information.

The file/metadata processing unit 240 functions to process the extracted file or metadata based on the determination. The file/metadata processing unit 240 may perform processing of a file or metadata using a method such as read, creation, modification, deletion, and the like. The file/metadata processing unit 240 may be separated into a file processing unit and a metadata processing unit. In this case, the file processing unit and the metadata processing unit may perform the same function as a file handler and a metadata handler, respectively. Meanwhile, when content of a shared file being shared is modified, the file/metadata processing unit 240 may function to modify content of metadata associated with the shared file.

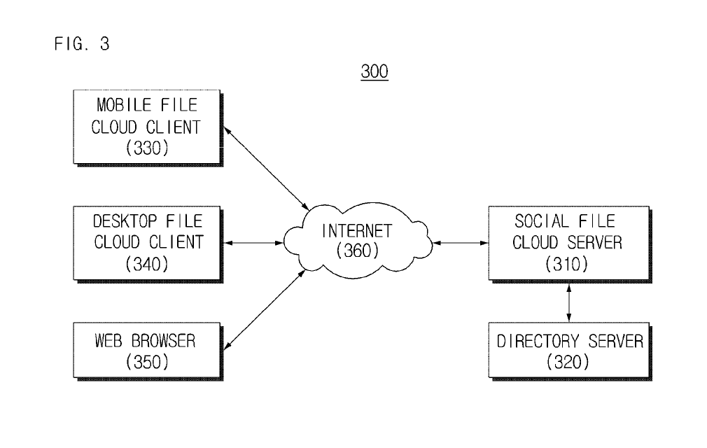

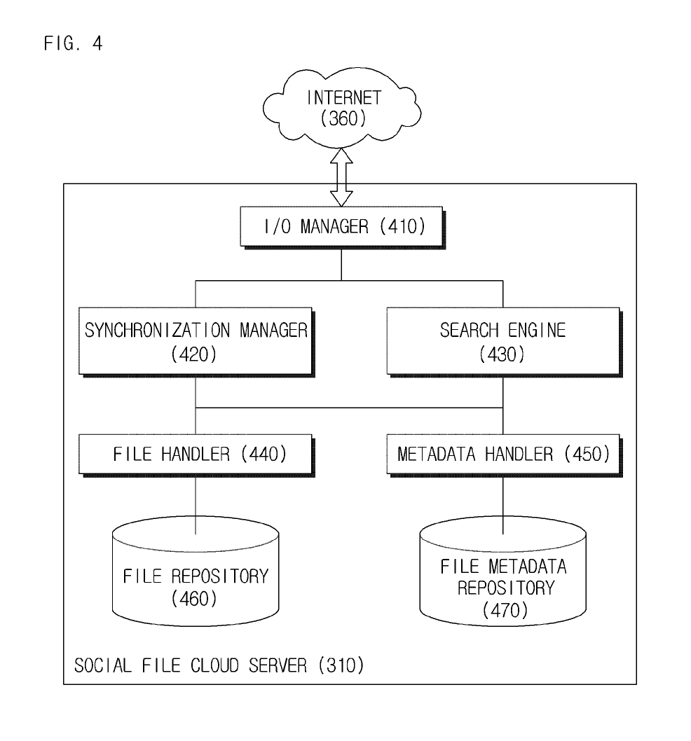

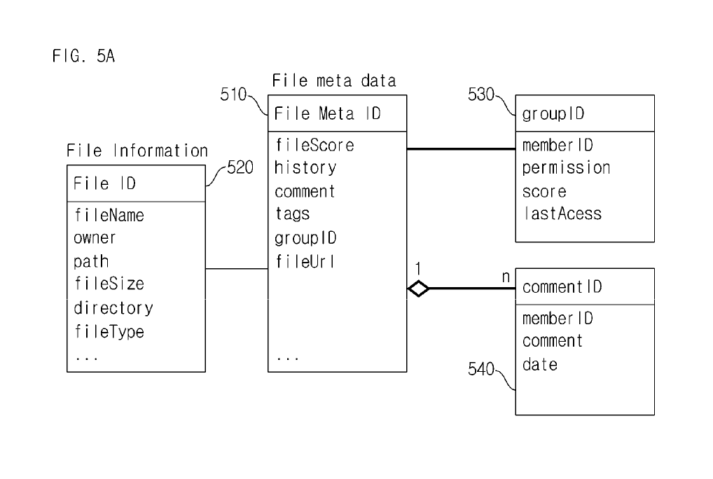

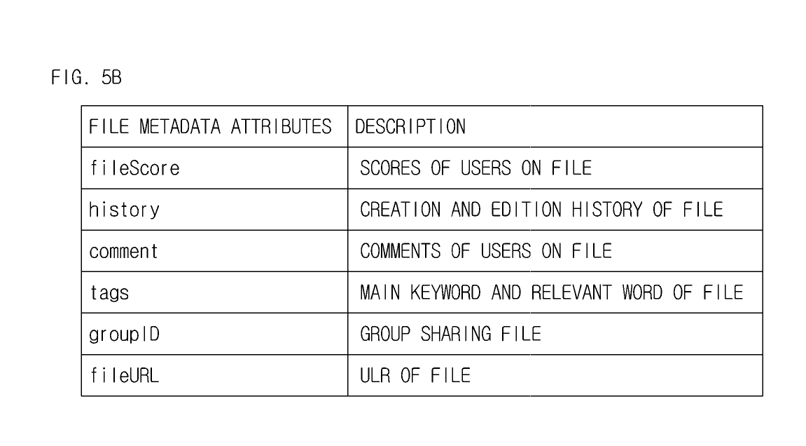

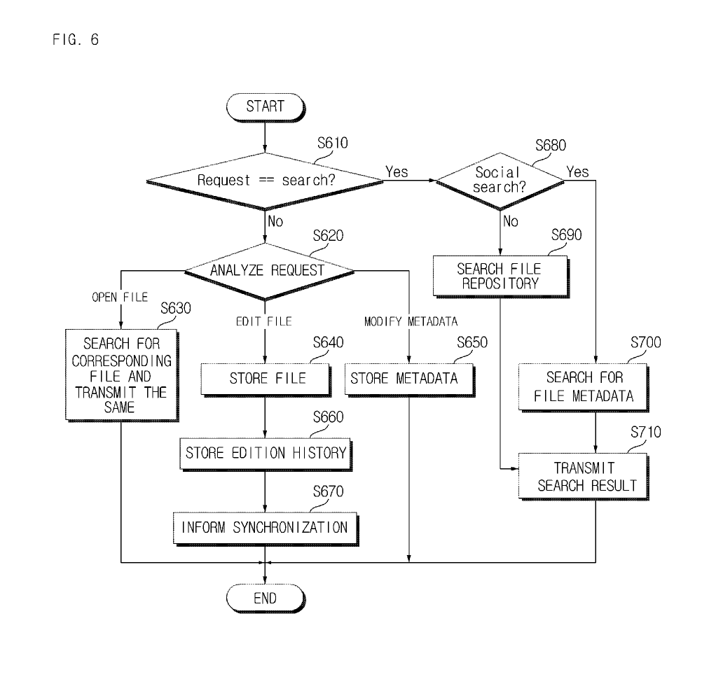

Next, a social file cloud service providing system will be described using an embodiment of a system that includes the file cloud service apparatus 100. FIG. 3 is a block diagram illustrating a structure of a social file cloud service providing system 300 using file metadata. FIG. 4 is a block diagram illustrating a structure of a social file cloud server. FIGS. 5A and 5B are diagrams illustrating a structure and an attribute of file metadata. FIG. 6 is a flowchart illustrating a procedure associated with a file read and search in a file cloud service. Hereinafter, a description will be made with reference to FIGS. 3 through 6.

A file cloud is a service that enables a plurality of users to share a single file, or enables a user to access the same file without restriction on a time and a place using various types of terminals, and to thereby perform a work. The social file cloud service providing system 300 is a system using metadata, and is a system that provides a user-oriented file cloud service by adding social information associated with a plurality of users to metadata and by providing comments or preferences of the users on a file.

The social file cloud service providing system 300 is generally classified into a social file cloud server 310 to manage a file and metadata, and file cloud clients 330 and 340 to provide an interface for a user in interaction with the social file cloud server 310.

To provide a user-oriented file cloud service, the social file cloud server 310 includes a comment on a file, scores on the file, and the like that are input by a user in a metadata repository of the file and thereby enables the comment, the scores, and the like to be used within a user sharing group.

The social file cloud server 310 interacts with a directory server 320 to manage group information for group sharing with the file. In an enterprise environment, a group may be configured based on an organization chart configuration. The organization chart information may be stored as group information in the directory server 320 and thereby be used.

The social file cloud server 310 manages a file and metadata repository in addition to the group information, inspects the right of a user, and informs modification of the file through synchronization with a client.

The file cloud clients 330 and 340 that interact with the social file cloud server 310 may be classified into the desk top file cloud client 340 that is driven on a desktop computer and the mobile file cloud client 330 that is driven on a mobile device connected to the Internet 360, such as a smart phone and a smart pad, and thereby be used. When there is no user terminal, the user may access the social file cloud server 310 using a web browser 350 without restriction on a time and a place, and thereby receive an authentication on the right to the file and then read or edit the file.

When a user logs in using a user interface that is provided by each client program to edit a file that is synchronized with a local and thereby is stored, or to edit a comment, scores, and the like on the file, the user requests the social file cloud server 310 for edition, and the social file cloud server 310 updates the file and metadata of the file based on the right of the user and performs synchronization by informing each client about the update.

As shown in FIG. 4, the social file cloud server 310 includes modules such as an I/O manager 410, a synchronization (sync) manager 420, a search engine 430, a file handler 440, a metadata handler 450, a file repository 460, a file metadata repository 470, and the like.

When a request for a file cloud service is transmitted to the I/O manager 410 through the Internet 360, a request message is analyzed. When the request message is a search, the request is transferred to the search engine 430. When the request message is other requests, that is, read, edition, and the like on a file or file metadata, the request is transferred to the sync manager 420. The sync manager 420 analyzes the request message, and performs a logic by calling the file handler 440 when the request message is a request for the file, the sync manager 420, and by calling the metadata handler 450 when the request message is a request for the file metadata. In this instance, only when a user right on the file is authenticated and then is allowed, the sync manager 420 performs an operation of read/modification/creation/deletion, and the like of the file. Storage of modification or history on the file may be additionally requested to the metadata handler 450. The metadata handler 450 functions to extract or modify necessary information in the file metadata repository 470 storing file metadata. As described above, the file metadata repository 470 functions to manage and store metadata information for providing a social file cloud service such as sharing group information on each file, a user comment on the file, scores of the user on the file, relevant tag information, usage history information on the file, and the like.

When a user request is a search, the search engine 430 analyzes a keyword. When the user request is a social search of which a search condition is scores or a comment of the user, the search engine 430 requests the metadata handler 450 for the corresponding search and calls the file handler 440 to handle a file associated with the search result. Based thereon, the user may perform various social searches such as a search for a file in an order of comments or scores of other users on the file shared within a group, a search for a file edited by a predetermined user based on a file history, and the like.

When the file is modified, the sync manager 420 searches for a corresponding client to inform other clients needing synchronization about the modification, and externally informs the modification using the I/O manager 410. File synchronization between a client and a server is performed.

File metadata stored in the file metadata repository 470 required to provide a social file cloud service has a structure as shown in FIG. 5A. The stored file metadata generally includes a basic information table 520 and a metadata information table 510 about a file. The basic information table 520 corresponds to a file title, a creator, a file path, a size and a type of the file, a folder name of the file, and the like, which are the same as information held by a general file manager. The metadata information table 510 includes social information. Scores on a file, a modification history of the file, comments of users on the file, tag information, a group sharing the file, a universal resource locator (URL) of the file enabling a direct access to the file from the Internet, and the like. In particular, a user comment information table 540 includes a user who has recorded a comment, a date, and the like. Therefore, search may be performed based on a comment of a predetermined user. A group information table 530 includes information about a user group.

FIG. 5B shows information about an attribute for each file metadata and a description thereof.

A procedure of providing a partial function of a social file cloud service is shown in FIG. 6. FIG. 6 shows a procedure in an aspect of main functions by omitting a user authentication or right procedure.

When the social file cloud server 310 receives a request from a client, the social file cloud server 310 analyzes a request message and determines whether the request message is a search (S610). When the request message is a search request, the social file cloud server 310 analyzes a keyword once more to thereby determine whether the search request is a social search requiring metadata (S680). In the case of the social search, the social file cloud server 310 searches the file metadata repository 470 for file metadata suitable for a search condition (S700). An example of search may include a search for a file on which a predetermined user has recorded a comment, a search for a file including a comment of a predetermined user, a search for a file having a comment including a predetermined word, a search for a file of which scores is higher than a predetermined value, and the like. After searching for metadata, the search result is transmitted together with basic information 520 associated with the corresponding file. In the case of a general search condition such as a simple file title or creator, instead of the social search, the social file cloud server 310 searches for general file information 520, additionally searches for information of a file repository (S690) and then transmits the search result (S710).

When the request message is not the search, the request message may be classified into three functions through re-analysis (S620). In the case of a file open request, the social file cloud server 310 searches for a corresponding file from the file repository 460 and transmits the file to a requester (S630). In the case of editing and then storing the file, the social file cloud server 310 stores the file in the file repository 460 (S640) and stores a file edition history in metadata of the corresponding file (S660). The social file cloud server 310 informs a client requiring synchronization about information used for the synchronization (S670). In the case of metadata modification, the social file cloud server 310 stores metadata in the file metadata repository 470 (S650).

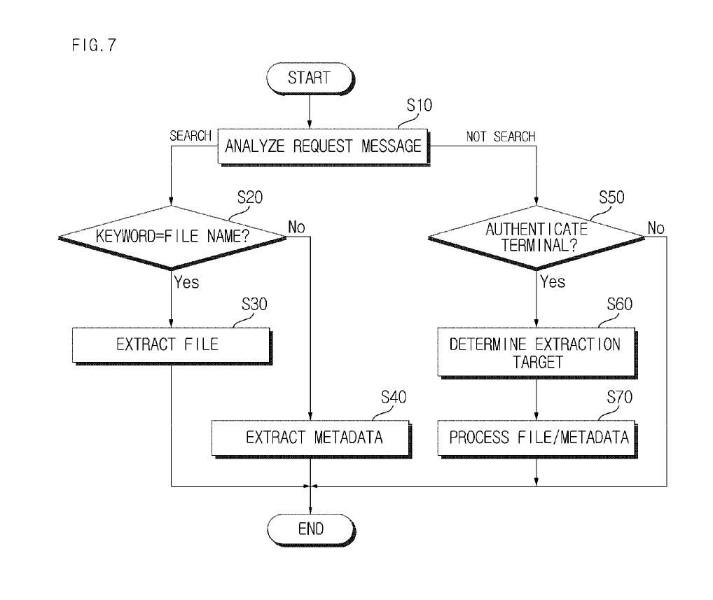

Next, a file cloud service method of the file cloud service apparatus 100 will be described. FIG. 7 is a flowchart illustrating a file cloud service method according to an exemplary embodiment of the present invention. Hereinafter, a description will be made with reference to FIGS. 1, 2A, 2B, and 7.

Initially, when a request message associated with a file cloud service is received, the request message analyzer 110 analyzes the request message (request message analyzing operation S10).

After the request message analyzing operation S10, when the analysis result of the request message is a search, the keyword interpreter 120 interprets a keyword included in the request message (keyword interpreting operation S20).

After the keyword interpreting operation S20, when the keyword is a file name, the file extractor 130 extracts, from among pre-stored files, a file that matches the file name (file extracting operation S30). In response to a request of a terminal having received the extracted file feature information, the file extractor 130 may extract a feature information based file, based on the extracted file feature information. In particular, the file extractor 130 may extract at least one of a file that includes a comment of a user selected using the feature information based file, a file that includes a word selected by the user comment, and a file of which scores or preference is greater than or equal to a reference value.

On the other hand, when the keyword is not the file name, the file feature information extractor 140 extracts file feature information associated with the keyword from among file feature information generated by the user using the file (file feature information extracting operation S40). The file feature information extractor 140 may extract, as the file feature information, at least one of a comment of the user on the file, and scores and preference of the user on the file that are included in metadata.

After the file extracting operation S30 or the file feature information extracting operation S40, the response message transmitter 150 includes the extracted file or the extracted file feature information in a response message to the request message and thereby transmits the response message (response message transmitting operation).

After the response message transmitting operation, a synchronizing operation may be performed. In the synchronizing operation, when content of a shared file being shared or metadata of the shared file is modified, the synchronizer 210 performs synchronization with all the terminals that receive a file cloud service for a shared file for updating.

Meanwhile, when the analysis result of the request message is not the search, the terminal authenticator 220 authenticates a transmission terminal having transmitted the request message (terminal authenticating operation S50).

After the terminal authenticating operation S50, the extraction target determining unit 230 determines whether to extract the file with respect to the authenticated transmission terminal, or whether to extract metadata including the file feature information (extraction target determining operation S60).

After the extraction target determining operation S60, the file/metadata processing unit 240 processes the extracted file or metadata based on the determination (file/metadata processing operation S70). When content of the shared file being shared is modified, the file/metadata processing unit 240 may change content of metadata associated with a shared file.

The terminal authenticating operation S50, the extraction target determining operation S60, and the file/metadata processing operation S70 are performed after the request message analyzing operation S10.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A file cloud service apparatus, comprising:
a request message analyzer to analyze a request message associated with a file cloud service when the request message is received;
a keyword interpreter to interpret a keyword included in the request message when the analysis result is a search;
a file extractor to extract, from among pre-stored files, a file that matches a file name when the keyword is the file name;
a file feature information extractor to extract file feature information associated with the keyword from among file feature information generated by a user using a file, when the keyword is not the file name; and
a response message transmitter to include the extracted file or the extracted file feature information in a response message to the request message and to thereby transmit the response message.

2. The apparatus of claim 1, wherein the file feature information extractor extracts, as the file feature information, at least one of a comment of a user on the file, and scores and preference of the user on the file that are included in metadata.

3. The apparatus of claim 1, further comprising:
a synchronizer to perform synchronization with all the terminals that receive a file cloud service for a shared file for updating, when content of the shared file being shared or metadata of the shared file is modified.

4. The apparatus of claim 1, further comprising:
a terminal authenticator to authenticate a transmission terminal having transmitted the request message when the analysis result is not the search;
an extraction target determining unit to determine whether to extract the file with respect to the authenticated transmission terminal, or whether to extract metadata including the file feature information; and
a file/metadata processing unit to process the extracted file or metadata based on the determination.

5. The apparatus of claim 4, wherein the file/metadata processing unit modifies content of metadata associated with a shared file when content of the shared file being shared is modified.

6. The apparatus of claim 1, wherein in response to a request of a terminal having received the extracted file feature information, the file extractor extracts a feature information based file, based on the extracted file feature information.

7. The apparatus of claim 6, wherein the file extractor extracts at least one of a file that includes a comment of a user selected using the feature information based file, a file that includes a word selected by the comment of the user, and a file of which scores or preference is greater than or equal to a reference value.

8. A file cloud service method, comprising:
analyzing a request message associated with a file cloud service when the request message is received;
interpreting a keyword included in the request message when the analysis a result is a search;
extracting, from among pre-stored files, a file that matches a file name when the keyword is the file name;
extracting file feature information associated with the keyword from among file feature information generated by a user using a file, when the keyword is not the file name; and
including the extracted file or the extracted file feature information in a response message to the request message to thereby transmit the response message.

9. The method of claim 8, wherein the extracting of the file feature information extracts, as the file feature information, at least one of a comment of a user on the file, and scores and preference of the user on the file that are included in metadata.

10. The method of claim 8, further comprising:
performing synchronization with all the terminals that receive a file cloud service for a shared file for updating, when content of the shared file being shared or metadata of the shared file is modified.

11. The method of claim 8, further comprising:
authenticating a transmission terminal having transmitted the request message when the analysis result is not the search;
determining whether to extract the file with respect to the authenticated transmission terminal, or whether to extract metadata including the file feature information; and
processing the extracted file or metadata based on the determination.

12. The method of claim 11, wherein the processing of the file or the metadata modifies content of metadata associated with a shared file when content of the shared file being shared is modified.

13. The method of claim 8, wherein the extracting of the file extracts a feature information based file based on the extracted file feature information in response to a request of a terminal having received the extracted file feature information, and extracts at least one of a file that includes a comment of a user selected using the feature information based file, a file that includes a word selected by the comment of the user, and a file of which scores or preference is greater than or equal to a reference value.
